(19) United States
(12) Patent Application Publication
(10) Pub. No.: US 2012/0292541 A1
(43) Pub. Date: Nov. 22, 2012

(54) HYDRAULIC HOUSING OF AN ELECTROHYDRAULIC VALVE CONTROLLER

(75) Inventors: Andreas RINNERT, HERZOGENAURACH (DE); Heiko SABLOTNY, HESSDORF (DE); Thomas KREMER, FUERTH (DE)

(73) Assignee: SCHAEFFLER TECHNOLOGIES AG & CO. KG, Herzogenaurach (DE)

(21) Appl. No.: 13/459,575

(22) Filed: Apr. 30, 2012

(30) Foreign Application Priority Data
May 16, 2011 (DE) 10 2011 075 894.1

(51) Int. Cl. F16K 31/12; B23K 20/12

(52) U.S. Cl. 251/30.01; 228/112.1

(57) ABSTRACT

A hydraulic housing of an electrohydraulic valve controller of an internal combustion engine which has a hydraulic housing body and guide cylinder for a pump piston that is joined to the hydraulic housing body. The guide cylinder is joined to the hydraulic housing body by a friction welded connection.

### FIELD OF THE INVENTION

The invention relates to a hydraulic housing of an electrohydraulic valve controller of an internal combustion engine that has a guide cylinder, which is joined to the hydraulic housing, for a pump piston.

### BACKGROUND OF THE INVENTION

Internal combustion engines with electrohydraulic valve controllers, in which substantial components required for hydraulic transmission of earn lobe lifts to gas exchange valves arranged in a preassembled hydraulic unit, which is fastened to the cylinder head, are known, and are mass-produced by the automobile manufacturer FIAT under the name “Multiair.” A main constituent part of the hydraulic unit is a hydraulic housing, which also emerges in the abovementioned form from DE 10 2006 008 676 A1 which is regarded as generic. FIG. 3 of the document clearly shows that the guide cylinder, which serves for mounting the pump piston, is joined to the hydraulic housing by a screw connection.

The joining connection however has with sonic disadvantages. Firstly, the preload force required for the durability of the screw connection may fall below an admissible value. This risk is present in particular in the case of a hydraulic housing produced from aluminum material. The internal thread of the hydraulic housing has a correspondingly low strength and, taking into consideration the high operating temperatures in conjunction with high and pulsating axially acting oil pressures, tends to exhibit plastic deformation due to contact pressures. Moreover, the production costs for the thread in the hydraulic housing and on the guide cylinder are not inconsiderable. Furthermore, the screw parameters, which must be kept within narrow limits, entail high assembly expenditure for the hydraulic housing.

### SUMMARY OF THE INVENTION

The invention is directed to improving the design of a hydraulic housing of the above-stated type with regard to reduced production and assembly expenditure.

Broadly, the invention relates to a hydraulic housing of an electrohydraulic valve controller of an internal combustion engine, which comprises a guide cylinder for a pump piston, where the guide cylinder is joined to the hydraulic housing by a friction-welded connection. The significant advantage of the joining connection is that the connection is specifically a non-detachable connection. The risk of premature detachment of the screw connection, which has hitherto been conventional at this location, is therefore eliminated entirely using proven means,

The friction-welded connection does not necessitate any restriction, or necessitates only a slight restriction, in material selection for the hydraulic housing and guide cylinder. Thus, it is possible for materials with very different physical properties to be connected to one another even under mass production conditions. This applies in particular to steel-steel or aluminum-aluminum material combinations, and in particular to the material combination of aluminum (hydraulic housing) with steel (guide cylinder), which is favored here.

As an alternative to the friction-welded connection according to the invention, other cohesive joining connections including adhesive bonding techniques are also conceivable, which may furthermore also extend to other components to be fastened to the hydraulic housing.

Further features of the invention will emerge from the following description and from the drawings, which illustrate an exemplary embodiment of the invention. Unless stated otherwise, identical or functionally identical features or components are denoted by the same reference numerals.

### BRIEF DESCRIPTION OF THE DRAWINGS

In the drawings:

FIG. 1 shows a hydraulic unit of an electrohydraulic valve controller in a perspective illustration;

FIG. 2 shows a cross-section through the hydraulic unit along a master unit mounted therein, as per the prior art;

FIG. 3 shows a cross-section through the hydraulic unit along a slave unit mounted therein;

FIG. 4 shows a cross-section through the hydraulic unit along a hydraulic valve mounted therein;

FIG. 5 shows the cross-section as per FIG. 2 with a hydraulic housing according to the invention before the friction welding of a guide cylinder for the pump piston, and

FIG. 6 is a view as in FIG. 5, after the friction welding of the guide cylinder.

### DETAILED DESCRIPTION OF THE INVENTION

FIG. 1 shows the overall view of a hydraulic unit 1, which is fully preassembled for installation into a cylinder head of a four-cylinder in-line internal combustion engine with electrohydraulic valve control. Master units 3 driven by a camshaft not illustrated) are accommodated in a hydraulic housing body 2, which is connected to the oil circuit of the internal combustion engine. Electromagnetic hydraulic valves 4 can be seen on the opposite longitudinal side of the hydraulic housing body 2 from the master units 3.

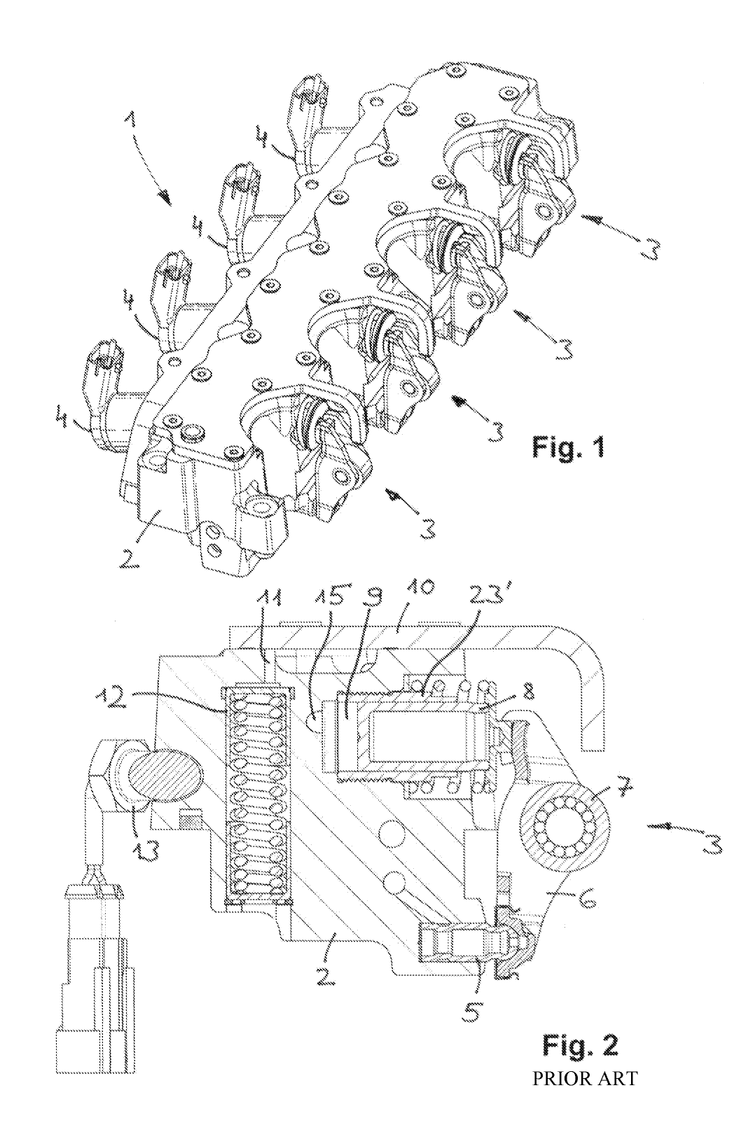

A cross-section through one of the master units 3, which are of identical design, is illustrated in FIG. 2. The master unit 3 comprises a rocker arm 6 which is articulately mounted on a rigid support element 5 and which has a rolling-bearing-mounted roller 7 as a cam pick-off surface and has a spring-loaded pump piston 8 which is driven by the rocker arm 6 and which delimits a pressure chamber 9 of variable volume. In order to control the hydraulic medium pressures prevailing in the pressure chamber 9, which lie in the region of 200 bar plus pressure peaks owing to the pressure pulsations, from a material aspect, the hydraulic housing body 2, which is closed off by a housing cover 10 screwed thereto, is formed as a pressure-tight aluminum forged part. When the hydraulic valve 4 is open, the pressure chamber 9 is connected to a pressure relief chamber 11, which in turn is delimited by a spring-loaded piston 12 of a pressure accumulator. A sensor 13 which is screwed into the hydraulic housing body 2 serves for measuring the hydraulic medium temperature.

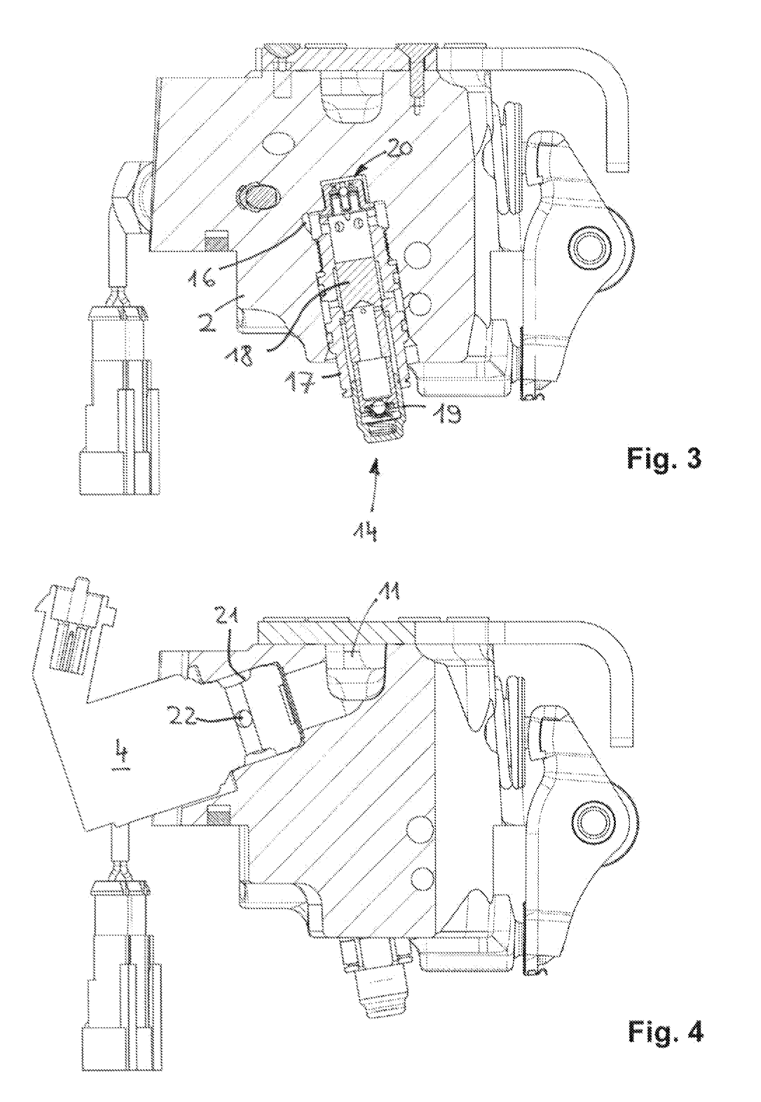

FIG. 3 shows a slave unit 14 for actuating one of the gas exchange valves of the internal combustion engine, which slave unit is hydraulically operatively connected to the pump piston 8 of the master unit 3 via ducts 15 as per FIG. 2 and 16 as per FIG. 3. The slave unit 14 comprises a slave housing 17 which is screwed into the hydraulic housing body 2, a slave piston 18 which is mounted in a longitudinally movable manner in said slave housing and which delimits the pressure chamber 9, a hydraulic valve play compensating element 19 which is braced between the slave piston 18 and the gas exchange valve, and a hydraulic valve brake 20. The latter ensures defined braking and soft closure of the gas exchange valve which, during the lifting phase, is hydraulically decoupled from the associated cam lobe and is loaded in the closing direction by the valve spring thereof whereas a fast outflow of hydraulic medium from the pressure chamber 9 into the pressure relief chamber 11 takes place when the hydraulic valve 4 is open (see, FIG. 2),

The separation of the pressure chamber 9 from the pressure relief chamber 11 by the hydraulic valve 4 can be seen from the cross-section along the hydraulic valve 4 illustrated in FIG. 4. The ducts 15 (see, FIG. 2) and 16 (see, FIG. 3) are hydraulically connected to one another by means of an annular groove 21 running on the hydraulic valve 4, such that the annular groove 21 and also the ducts 15 and 16 are constituent parts of the pressure chamber 9 (see, FIG. 2). In the open state, the hydraulic valve 4 permits a transfer flow of hydraulic medium from the pressure chamber 9 into the pressure relief chamber 11 and hack via a bore 22 which connects the pressure relief chamber 11 to the annular groove 21.

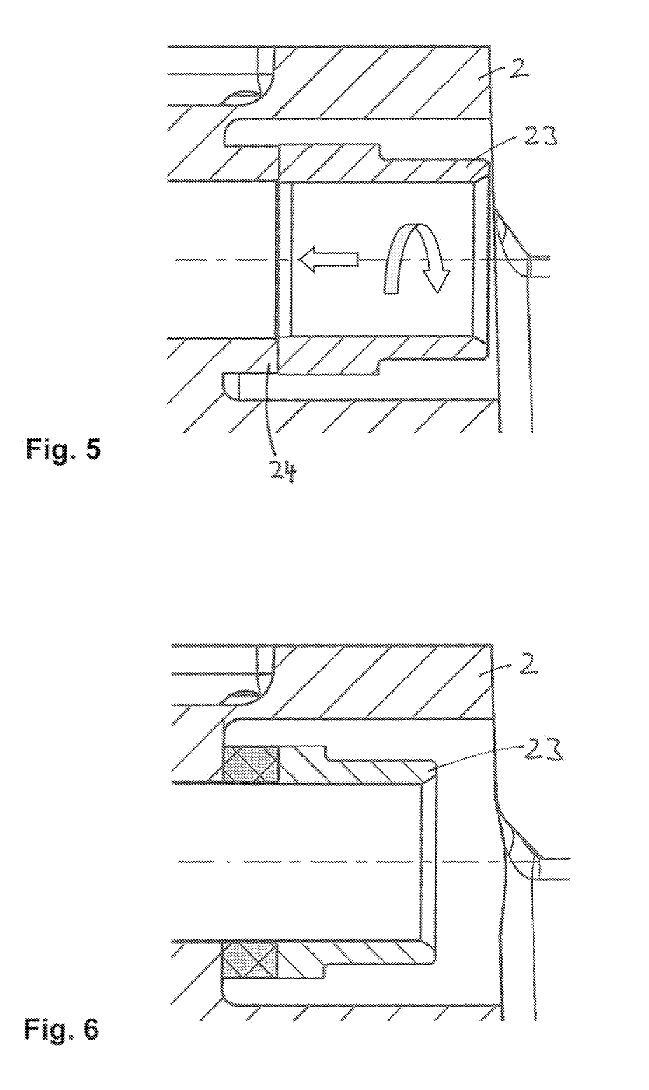

The master unit 3 illustrated in FIG. 2 is of a known design. The pump piston 8 is mounted in a longitudinally movable manner in a guide cylinder 23 which is screwed into the hydraulic housing body 2. As explained in the introduction, this type of fastening is associated with disadvantages and risks with regard to high production and assembly expenditure and a premature detachment of the screw connection, and is to be replaced according to the invention by the friction-welded connection depicted in FIGS. 5 and 6. These figures illustrate the guide cylinder 23, which is structurally adapted for this joining process and is composed of steel material, before and after the welding to the hydraulic housing body 2, which as in the known design with a screw connection, is composed of aluminum material. As indicated by the arrows plotted in FIG. 5, in the rotary friction welding process used here, the guide cylinder 23 is set in rotation and pressed against an annular projection 24 of the static hydraulic housing body 2, wherein the friction heat at the contact regions in conjunction with the upsetting force leads to the durable welded connection of the two components. The welded-together material structure is schematically illustrated in FIG. 6 by the cross-hatched region.

### LIST OF REFERENCE NUMERALS

1 Hydraulic Unit
2 Hydraulic Housing Body
3 Master Unit
4 Hydraulic Valve
5 Support Element
6 Rocker Arm
7 Roller
8 Pump Piston
9 Pressure Chamber
10 Housing Cover
11 Pressure Relief Chamber
12 Pressure Accumulator Piston
13 Temperature Sensor
14 Slave Unit
15 Duct
16 Duct
17 Slave Housing
18 Slave Piston
19 Valve Play Compensating Element
20 Valve Brake
21 Annular Groove
22 Bore
23 Guide Cylinder
24 Projection

What is claimed:

1. A hydraulic housing of an electrohydraulic valve controller of an internal combustion engine, comprising:
a hydraulic housing body; and
a guide cylinder for a pump piston,
wherein the guide cylinder is joined to the hydraulic housing body by a friction-welded connection.

2. The hydraulic housing according to claim 1, wherein the hydraulic housing body is composed of an aluminum material and the guide cylinder is composed of a steel material.

3. The hydraulic housing according to claim 1, wherein the hydraulic housing body and the guide cylinder are each composed of an aluminum material.

4. A method for producing a hydraulic housing of an electrohydraulic valve controller of an internal combustion engine, comprising the step of:
providing a housing body; and
joining a guide cylinder for a pump piston to the housing body by friction welding.
